(19) United States
(12) Patent Application Publication
(10) Pub. No.: US 2025/0257083 A1
(43) Pub. Date: Aug. 14, 2025

(54) FULLY-CONTINUOUS SYNTHESIS METHOD OF GLYPHOSATE

(71) Applicants: HUBEI TRISUN CHEMICALS CO.,LTD., Yichang (CN); HUBEI XINGFA CHEMICALS GROUP CO.,LTD., Yichang (CN)

(72) Inventors: Fener CHEN, Yichang (CN); Xianjing ZHENG, Yichang (CN); Chang LIU, Yichang (CN); Yiqun TIAN, Yichang (CN); Yajiao ZHANG, Yichang (CN); Li WAN, Yichang (CN); Chunxue PENG, Yichang (CN); Songlin ZHENG, Yichang (CN); Liangchuan LAI, Yichang (CN)

(21) Appl. No.: 19/098,228

(22) Filed: Apr. 2, 2025

(30) Foreign Application Priority Data
Apr. 24, 2024 (CN) 202410496227.3

(51) Int. Cl. C07F 9/38

(52) U.S. Cl. CPC C07F 9/3813

(57) ABSTRACT

A fully-continuous synthesis method of glyphosate is provided, which is performed by using a fully-continuous system including a feed pump, a plurality of micromixers, a plurality of microchannel reactors, a dynamic rotary reactor, a buffer tank, a back pressure valve, a plurality of reaction vessels and a continuous crystallizer. Glycine is used as a raw material, and reacted with a paraformaldehyde depolymerization product to yield N, N-dihydroxymethylglycine, which further undergoes esterification with dimethyl phosphite to generate methyl glyphosate. The methyl glyphosate is adjusted to be acidic, desolvated, hydrolyzed and purified to obtain glyphosate.

### CROSS-REFERENCE TO RELATED APPLICATIONS

This application claims the benefit of priority from Chinese Patent Application No. 202410496227.3, filed on Apr. 24, 2024. The content of the aforementioned application, including any intervening amendments made thereto, is incorporated herein by reference in its entirety.

### TECHNICAL FIELD

This application relates to organic synthesis, and more particularly to a fully-continuous synthesis method of glyphosate.

### BACKGROUND

Glyphosate is a potent, low-toxic, broad-spectrum biocide herbicide, which is one of the most valuable organophosphorus pesticides discovered so far. Glyphosate has broad-spectrum activity, low toxicity, no residue, systemic conduction, excellent non-selectivity. Due to the systemic conduction effect, glyphosate can dissolve the wax layer on the surface of the weed leaf diameter, enabling the drug efficacy to quickly enter the plant conduction system to take effect, thereby causing the weeds to wither and die. Glyphosate is the pesticide variety with the fastest growing demand and the technical pesticide with the largest global production, accounting for 60% of the entire herbicide market. At present, the synthesis of glyphosate mainly adopts the glycine method and the iminodiacetic acid method. The glycine method is the main process used in China. Glycine, polyformaldehyde and dimethyl phosphite are used as raw materials for reaction in the presence of triethylamine to obtain glyphosate. However, this method has always resulted in low yields (generally 75%-85%) and low purity due to the large number of by-products. The production process always adopts reaction vessels, which has a low degree of continuity and low efficiency. In addition, the production process is cumbersome, and many steps require temperature and speed control and harsh conditions. This seriously affects the quality of each batch of glyphosate, resulting in uneven product quality, and is thus not conducive to industrial production.

Chinese patent publications No. 115232167A, No. 116102592A and No. 116041388A disclosed the preparation of glyphosate through continuous hydrolysis of methyl glyphosate. Chinese patent No. 104163832B disclosed a reaction-vessel-type continuous synthesis process of glyphosate, which still fails to meet the requirements of large-scale industrial continuous production. The batch synthesis seriously affects the glyphosate quality in individual batches, leading to uneven product quality, which is unfavorable for industrial production. The continuous synthesis from paraformaldehyde to methyl glyphosate has not been reported yet.

### SUMMARY

An object of the disclosure is to provide a fully-continuous synthesis method of glyphosate with high production efficiency, and excellent product quality and consistency, so as to overcome the problems of uneven product quality, low purity caused by numerous by-products and complicated production process in the existing reaction-vessel-type production processes for glyphosate.

In order to achieve the above object, the following technical solutions are adopted.

This application provides a fully-continuous synthesis method of glyphosate using a fully-continuous synthesis system, the fully-continuous synthesis system comprising a first micromixer, a second micromixer, a third micromixer, a fourth micromixer, a first microchannel reactor, a second microchannel reactor, a third microchannel reactor, a fourth microchannel reactor, a fifth microchannel reactor, a sixth microchannel reactor, a dynamic rotary reactor, a buffer tank, a first back pressure valve, a second back pressure valve, a first reaction vessel, a second reaction vessel, a third reaction vessel, and a continuous crystallizer; and the fully-continuous synthesis method comprising:
(1) dissolving paraformaldehyde in a first solvent to obtain a first reactant liquid; dissolving a base in a second solvent to obtain a second reactant liquid; mixing the first raw material liquid with the second raw material liquid in the first micromixer followed by depolymerization in the first microchannel reactor to obtain a depolymerization product; dissolving or dispersing glycine in a third solvent to obtain a third reactant liquid; mixing the third reactant liquid with the depolymerization product in the second micromixer followed by addition reaction in the second microchannel reactor to generate a N, N-dihydroxymethylglycine-containing reaction mixture; transporting the N, N-dihydroxymethylglycine-containing reaction mixture to the buffer tank; and quantitatively outputting, by a plunger pump, the N, N-dihydroxymethylglycine-containing reaction mixture from the buffer tank to the third micromixer;
(2) mixing the N, N-dihydroxymethylglycine-containing reaction mixture with dimethyl phosphite in the third micromixer followed by esterification reaction in the third microchannel reactor and the fourth microchannel reactor to generate a methyl glyphosate-containing reaction mixture, wherein a temperature of the fourth microchannel reactor is higher than that of the third microchannel reactor, and a reaction pressure in the third microchannel reactor and a reaction pressure in the fourth microchannel reactor are adjusted by the first back pressure valve; and
(3) transporting the methyl glyphosate-containing reaction mixture to the fourth micromixer through the first back pressure valve; mixing the methyl glyphosate-containing reaction mixture with an acid in the fourth micromixer followed by neutralization reaction in the fifth microchannel reactor to obtain an acidic reaction mixture; transporting the acidic reaction mixture to the sixth microchannel reactor for heating, wherein a pressure of the fifth microchannel reactor and a pressure of the sixth microchannel reactor are adjusted by the second back pressure valve; transporting the acidic reaction mixture to the first reaction vessel through the second back pressure valve for desolventization to obtain a desolvated product; transporting the desolvated product sequentially to the second reaction vessel and the third reaction vessel to allow complete hydrolysis reaction, so as to obtain a hydrolysis product; transporting the hydrolysis product to the continuous crystallizer for cooling crystallization to obtain a crude glyphosate product; and subjecting the crude glyphosate product to filtration and drying to obtain a glyphosate finished product with a purity greater than 98% and a total yield greater than 85% based on glycine.

In some embodiments, in step (1), the base is selected from the group consisting of liquid ammonia, triethylamine, trimethylamine, tributylamine, diethylamine, N, N-diisopropylethylamine and sodium methoxide; and in step (3), the acid is selected from the group consisting of a 10% aqueous hydrogen chloride solution, a 20% aqueous hydrogen chloride solution, a 30% aqueous hydrogen chloride solution, a 37% aqueous hydrogen chloride solution, a methanolic hydrogen chloride solution, formic acid, acetic acid, a 10% aqueous phosphoric acid solution, a 20% aqueous phosphoric acid solution, a 30% aqueous phosphoric acid solution and a 37% aqueous phosphoric acid solution.

In some embodiments, in step (1), the first solvent and the third solvent are each independently selected from the group consisting of pentanol, n-butanol, isobutanol, tert-butanol, n-propanol, isopropanol, ethanol, methanol, ethyl ether, acetone, butanone and methyl isobutyl ketone.

In some embodiments, the dimethyl phosphite is fed into the third micromixer in a solvent-free manner or in the presence of a fourth solvent;

the acid is fed into the fourth micromixer in a solvent-free manner or in the presence of a fifth solvent; and

the second solvent, the fourth solvent and the fifth solvent are each independently selected from the group consisting of water, pentanol, n-butanol, isobutanol, tert-butanol, n-propanol, isopropanol, ethanol, methanol, acetone and methyl isobutyl ketone.

In some embodiments, in step (1), a molar ratio of the base to the glycine is 0.6-0.95:1, and a molar ratio of the paraformaldehyde to the glycine is 1.0-3.0:1; and in step (2), a molar ratio of the dimethyl phosphite to the glycine is 1.0-1.4:1, and a molar ratio of the acid to the glycine is 1.0-10:1.

In some embodiments, the depolymerization is performed in the first microchannel reactor at 30-60° C. for 1-9 min;

the addition reaction is performed in the second microchannel reactor at 45-80° C. for 6-12 min;

the esterification reaction is performed in the third microchannel reactor at 50-80° C. for 1-8 min;

the esterification reaction is performed in the fourth microchannel reactor at 60-90°° C. for 5-15 min;

the neutralization reaction is performed in the fifth microchannel reactor at 0-30° C. for 0.5-3 min;

the acidic reaction mixture is heated in the sixth microchannel reactor at 90-190° C., and a residence time of the acidic reaction mixture in the sixth microchannel reactor is 0.5-3 min;

the first reaction vessel is set at 80-150° C., and a residence time of the acidic reaction mixture in the first reaction vessel is 5-40 min;

the hydrolysis reaction is performed in the second reaction vessel at 80-150° C. for 5-40 min;

the hydrolysis reaction is performed in the third reaction vessel at 90-160° C. for 5-40 min; and

the cooling crystallization is performed in the continuous crystallizer at 0-80° C. for 1-30 min.

In some embodiments, the first micromixer and the second micromixer are configured to perform dynamic vortex mixing, each having an inlet size of 1.0-50 mm, an outlet size of 1.0-50 mm, a mixing chamber diameter of 5.0-500 mm and a height of 5.0-100 mm;

the third micromixer and the fourth micromixer are each a Z-shaped plate-type micromixer with an inner diameter of 0.5-50 mm and a length of 0.1-100 m; and

each of the first microchannel reactor, the second microchannel reactor, the third microchannel reactor, the fourth microchannel reactor, the fifth microchannel reactor and the sixth microchannel reactor has a plate or tubular microchannel structure with an inner diameter of 1.0-100 mm and a length of 10-10000 m.

In some embodiments, the dynamic rotary reactor is a horizontal or vertical multi-stage rotary stirring reactor having a heat exchange jacket, a circular interior structure, an inner diameter of 10-500 mm and a length of 0.1-50 m;

the first reaction vessel, the second reaction vessel and the third reaction vessel each have a diameter of 5-1000 mm and an aspect ratio of 5-50:1; and

the continuous crystallizer has an inlet size of 1.0-50 mm, an outlet size of 10-200 mm, an inner diameter of 1.0-50 mm and a length of 1-200 m.

In some embodiments, a pressure of the first back pressure valve is 1-10 bar, and a pressure of the second back pressure valve is 1-20 bar.

In some embodiments, the cooling crystallization is performed in the presence of a solvent selected from the group consisting of water, methanol, ethanol, propanol and isopropanol.

Compared to the prior art, the present disclosure has the following beneficial effects.

(1) The micromixer can greatly enhance mass transfer effect of a multiphase system, increase the reaction rate, and reduce the reactor volume. Moreover, the microchannel reactor has excellent mass transfer, heat transfer and continuous material mixing and strengthening performances, which can effectively shorten the reaction time, improve the reaction efficiency and the flux per unit volume of the reactor, resulting in higher reaction safety. In addition, three wastes and energy consumption are significantly reduced. Compared with the 5-10 h of traditional intermittent reactor reaction, the present disclosure can complete the preparation of glyphosate in 1-2 h.
(2) The present disclosure realizes stable and fully-continuous industrial production from raw materials to glyphosate. The process is carried out continuously and uninterruptedly, with a high degree of automation, no external intervention in the intermediate process and high time and space efficiency, greatly reducing the number of operators and labor intensity, and significantly reducing production costs.
(3) The present disclosure avoids the cumbersome operation, the danger of heating and spraying in traditional reaction-vessel-type processes, thereby improving production safety, and ensuring the quality of glyphosate products.
(4) The product obtained by the present disclosure has a purity of more than 98% and a total yield of more than 85% based on glycine.

### BRIEF DESCRIPTION OF THE DRAWINGS

FIG. 1 is a flow chart of a fully-continuous synthesis method of glyphosate in accordance with an embodiment of the present disclosure.

### DETAILED DESCRIPTION OF EMBODIMENTS

The present disclosure will be further described with reference to the accompanying drawings and embodiments. The embodiments disclosed herein are merely illustrative of the disclosure, and are not intended to limit the present disclosure.

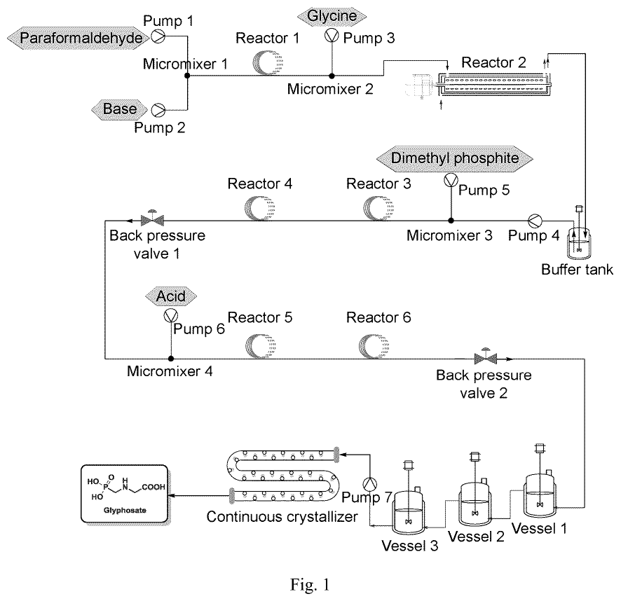

This application provides a fully-continuous synthesis of glyphosate, which is schematically shown in the FIG. 1.

### EXAMPLE 1

Paraformaldehyde (0.4 kg/L, 2.2 eq) was dispersed in methanol to obtain a first reactant liquid. Tributylamine (0.8 eq) was dispersed in methanol to obtain a second reactant liquid. The first reactant liquid was pumped into a micromixer 1 by a pump 1, and the second reactant liquid were pumped into the micromixer 1 by pump 2. The first reactant liquid was fully mixed with the second reactant liquid in the micromixer 1, and then subjected to depolymerization in a microchannel reactor 1 at 50° C. for 5 min to obtain a depolymerization product. Glycine (0.5 kg/L, 1.1 eq) was dispersed in methanol to obtain a third reactant liquid. The third reactant liquid was pumped into micromixer 2 by pump 3, fully mixed with the depolymerization product flowing out of the microchannel reactor 1 in the micromixer 2, and transported to a reactor 2 (a dynamic tubular reactor) for addition reaction at 60° C. for 8 min to generate a N, N-dihydroxymethylglycine-containing reaction mixture. The N, N-dihydroxymethylglycine-containing reaction mixture was transported to a buffer tank, and quantitatively output by a plunger pump.

The N, N-dihydroxymethylglycine-containing reaction mixture was pumped into a micromixer 3 by a pump 4. A methanol solution of dimethyl phosphite (0.2 kg/L, 1.1 eq) was pumped into the micromixer 3 by pump 5. The N, N-dihydroxymethylglycine-containing reaction mixture was fully mixed with the methanol solution of dimethyl phosphite in the micromixer 3, then transported to a microchannel reactor 3 for esterification reaction at 65° C. for 5 min, and then transported to a microchannel reactor 4 for further reaction to generate a methyl glyphosate-containing reaction mixture. In order to promote the reaction to proceed completely, the microchannel reactor 4 was set at 70° C., and a retention time of the reaction mixture in the microchannel reactor 4 was 3 min, thereby allowing the reaction to be completely carried out to generate methyl glyphosate. The methyl glyphosate-containing reaction mixture was outputted to enter a back pressure valve 1 (7 bar). Reaction pressures in the microchannel reactors 3 and 4 were adjusted by the back pressure valve 1.

The methyl glyphosate-containing reaction mixture was transported to a micromixer 4 through the back pressure valve 1. A 30% hydrochloric acid solution was pumped into the micromixer 4 by pump 6. The methyl glyphosate-containing reaction mixture was fully mixed with the 30% hydrochloric acid solution in the micromixer 4, and then transported to microchannel reactor 5 for neutralization reaction at 10° C. for 1 min to obtain an acidic reaction mixture. The acidic reaction mixture was directly transported to a microchannel reactor 6 for rapid heating. After being heated to 85° C., the acidic reaction mixture was transported to a back pressure valve 2 (4 bar). Pressures of the microchannel reactors 5 and 6 were controlled and adjusted by the back pressure valve 2. The acidic reaction mixture was outputted from the back pressure valve 2 to enter a reaction vessel 1 for desolventization at 90°° C. for 20 min to remove solvents, low-boiling methanol and by-product methyl chloride to obtain a desolvated product. The desolvated product was sequentially transported to a reaction vessel 2 for hydrolysis reaction at 105° C. for 25 min, and continuously transported to a reaction vessel 3 for complete hydrolysis reaction at 120° C. for 30 min, so as to obtain a hydrolysis product. During the hydrolysis reaction, water in the reaction system was continuously evaporated, the temperature of the reaction mixture was increased to promote the hydrolysis reaction rate. The hydrolysis product in the reaction vessel 3 was directly transported to a continuous crystallizer for cooling crystallization to obtain a crude glyphosate product. The crude glyphosate product was filtered and dried to obtain a glyphosate finished product with a purity of 97%, a total yield of 86% based on glycine. The total reaction time was 59 min.

### EXAMPLE 2

Paraformaldehyde (0.5 kg/L, 2.5 eq) was dispersed in methanol to obtain a first reactant liquid. Tributylamine (0.9 eq) was dispersed in methanol to obtain a second reactant liquid. The first reactant liquid was pumped into a micromixer 1 by a pump 1, and the second reactant liquid were pumped into the micromixer 1 by a pump 2. The first reactant liquid was fully mixed with the second reactant liquid in the micromixer 1, and then subjected to depolymerization in a microchannel reactor 1 at 55° C. for 6 min to obtain a depolymerization product. Glycine (0.6 kg/L, 1.0 eq) was dispersed in methanol to obtain a third reactant liquid. The third reactant liquid was pumped into a micromixer 2 by a pump 3, fully mixed with the depolymerization product flowing out of the microchannel reactor 1 in the micromixer 2, and transported to a reactor 2 for addition reaction at 55° C. for 7 min to generate a N, N-dihydroxymethylglycine-containing reaction mixture. The N, N-dihydroxymethylglycine-containing reaction mixture was transported to a buffer tank, and quantitatively output by a plunger pump.

The N, N-dihydroxymethylglycine-containing reaction mixture was pumped into a micromixer 3 by a pump 4. A methanol solution of dimethyl phosphite (0.3 kg/L, 1.2 eq) was pumped into the micromixer 3 by a pump 5. The N, N-dihydroxymethylglycine-containing reaction mixture was fully mixed with the methanol solution of dimethyl phosphite in the micromixer 3, then transported to a microchannel reactor 3 for esterification reaction at 60°° C. for 7 min, and then transported to a microchannel reactor 4 for further reaction to generate a methyl glyphosate-containing reaction mixture. In order to promote the reaction to proceed completely, the microchannel reactor 4 was set at 70° C., and a retention time of the reaction mixture in the microchannel reactor 4 was 4 min, thereby allowing the reaction to be completely carried out to generate methyl glyphosate. The methyl glyphosate-containing reaction mixture was outputted to enter a back pressure valve 1 (8 bar). Reaction pressures in the microchannel reactors 3 and 4 were adjusted by the back pressure valve 1.

The methyl glyphosate-containing reaction mixture was transported to a micromixer 4 through the back pressure valve 1. A 31.5% hydrochloric acid solution was pumped into the micromixer 4 by a pump 6. The methyl glyphosate-containing reaction mixture was fully mixed with the 31.5% hydrochloric acid solution in the micromixer 4, and then transported to a microchannel reactor 5 for neutralization reaction at 5° C. for 1.5 min to obtain an acidic reaction mixture. The acidic reaction mixture was directly transported to a microchannel reactor 6 for rapid heating. After being heated to 90° C., the acidic reaction mixture was transported to a back pressure valve 2 (5 bar). Pressures of the microchannel reactors 5 and 6 were controlled and adjusted by the back pressure valve 2. The acidic reaction mixture was outputted from the back pressure valve 2 to enter a reaction vessel 1 for desolventization at 100°° C. for 22 min to remove solvents, low-boiling methanol and by-product methyl chloride to obtain a desolvated product. The desolvated product was sequentially transported to a reaction vessel 2 for hydrolysis reaction at 110° C. for 27 min, and continuously transported to a reaction vessel 3 for complete hydrolysis reaction at 125° C. for 33 min, so as to obtain a hydrolysis product. During the hydrolysis reaction, water in the reaction system was continuously evaporated, the temperature of the reaction mixture was increased to promote the hydrolysis reaction rate. The hydrolysis product in the reaction vessel 3 was directly transported to a continuous crystallizer for cooling crystallization to obtain a crude glyphosate product. The crude glyphosate product was filtered and dried to obtain a glyphosate finished product with a purity of 98%, a total yield of 85.5% based on glycine. The total reaction time was 74.5 min.

### EXAMPLE 3

Paraformaldehyde (0.1 kg/L, 2.0 eq) was dispersed in methanol to obtain a first reactant liquid. Triethylamine (0.8 eq) was dispersed in methanol to obtain a second reactant liquid. The first reactant liquid was pumped into a micromixer 1 by a pump 1, and the second reactant liquid were pumped into the micromixer 1 by a pump 2. The first reactant liquid was fully mixed with the second reactant liquid in the micromixer 1, and then subjected to depolymerization in a microchannel reactor 1 at 50° C. for 5 min to obtain a depolymerization product. Glycine (0.7 kg/L, 1.0 eq) was dispersed in methanol to obtain a third reactant liquid. The third reactant liquid was pumped into micromixer 2 by pump 3, fully mixed with the depolymerization product flowing out of the microchannel reactor 1 in the micromixer 2, and transported to a reactor 2 for addition reaction at 50°° C. for 5 min to generate a N, N-dihydroxymethylglycine-containing reaction mixture. The N, N-dihydroxymethylglycine-containing reaction mixture was transported to a buffer tank, and quantitatively output by a plunger pump.

The N, N-dihydroxymethylglycine-containing reaction mixture was pumped into a micromixer 3 by a pump 4. A methanol solution of dimethyl phosphite (0.3 kg/L, 1.4 eq) was pumped into the micromixer 3 by a pump 5. The N, N-dihydroxymethylglycine-containing reaction mixture was fully mixed with the methanol solution of dimethyl phosphite in the micromixer 3, then transported to a microchannel reactor 3 for esterification reaction at 70° C. for 4 min, and then transported to a microchannel reactor 4 for further reaction to generate a methyl glyphosate-containing reaction mixture. In order to promote the reaction to proceed completely, the microchannel reactor 4 was set at 75° C., and a retention time of the reaction mixture in the microchannel reactor 4 was 2.5 min, thereby allowing the reaction to be completely carried out to generate methyl glyphosate. The methyl glyphosate-containing reaction mixture was outputted to enter a back pressure valve 1 (4 bar). Reaction pressures in the microchannel reactors 3 and 4 were adjusted by the back pressure valve 1.

The methyl glyphosate-containing reaction mixture was transported to a micromixer 4 through the back pressure valve 1. A 20% hydrochloric acid solution was pumped into the micromixer 4 by a pump 6. The methyl glyphosate-containing reaction mixture was fully mixed with the 20% hydrochloric acid solution in the micromixer 4, and then transported to a microchannel reactor 5 for neutralization reaction at 0° C. for 3 min to obtain an acidic reaction mixture. The acidic reaction mixture was directly transported to a microchannel reactor 6 for rapid heating. After being heated to 100° C., the acidic reaction mixture was transported to a back pressure valve 2 (6 bar). Pressures of the microchannel reactors 5 and 6 were controlled and adjusted by the back pressure valve 2. The acidic reaction mixture was outputted from the back pressure valve 2 to enter a reaction vessel 1 for desolventization at 110° C. for 28 min to remove solvents, low-boiling methanol and by-product methyl chloride to obtain a desolvated product. The desolvated product was sequentially transported to a reaction vessel 2 for hydrolysis reaction at 115° C. for 35 min, and continuously transported to a reaction vessel 3 for complete hydrolysis reaction at 125° C. for 35 min, so as to obtain a hydrolysis product. During the hydrolysis reaction, water in the reaction system was continuously evaporated, the temperature of the reaction mixture was increased to promote the hydrolysis reaction rate. The hydrolysis product in the reaction vessel 3 was directly transported to a continuous crystallizer for cooling crystallization to obtain a crude glyphosate product. The crude glyphosate product was filtered and dried to obtain a glyphosate finished product with a purity of 97%, a total yield of 85% based on glycine. The total reaction time was 82.5 min.

### EXAMPLE 4

Paraformaldehyde (0.7 kg/L, 2.5 eq) was dispersed in ethanol to obtain a first reactant liquid. Tributylamine (0.8 eq) was dispersed in ethanol to obtain a second reactant liquid. The first reactant liquid was pumped into a micromixer 1 by a pump 1, and the second reactant liquid were pumped into the micromixer 1 by pump 2. The first reactant liquid was fully mixed with the second reactant liquid in the micromixer 1, and then subjected to depolymerization in a microchannel reactor 1 at 50° C. for 6 min to obtain a depolymerization product. Glycine (0.7 kg/L, 1.2 eq) was dispersed in ethanol to obtain a third reactant liquid. The third reactant liquid was pumped into a micromixer 2 by a pump 3, fully mixed with the depolymerization product flowing out of the microchannel reactor 1 in the micromixer 2, and transported to a reactor 2 for addition reaction at 65° C. for 10 min to generate a N, N-dihydroxymethylglycine-containing reaction mixture. The N, N-dihydroxymethylglycine-containing reaction mixture was transported to a buffer tank, and quantitatively output by a plunger pump.

The N, N-dihydroxymethylglycine-containing reaction mixture was pumped into a micromixer 3 by a pump 4. An ethanol solution of dimethyl phosphite (0.5 kg/L, 1.4 eq) was pumped into the micromixer 3 by a pump 5. The N, N-dihydroxymethylglycine-containing reaction mixture was fully mixed with the ethanol solution of dimethyl phosphite in the micromixer 3, then transported to microchannel reactor 3 for esterification reaction at 65° C. for 5 min, and then transported to a microchannel reactor 4 for further reaction to generate a methyl glyphosate-containing reaction mixture. In order to promote the reaction to proceed completely, the microchannel reactor 4 was set at 70°° C., and a retention time of the reaction mixture in the microchannel reactor 4 was 1 min, thereby allowing the reaction to be completely carried out to generate methyl glyphosate. The methyl glyphosate-containing reaction mixture was outputted to enter back pressure valve 1 (9 bar). Reaction pressures in the microchannel reactors 3 and 4 were adjusted by the back pressure valve 1.

The methyl glyphosate-containing reaction mixture was transported to a micromixer 4 through the back pressure valve 1. A 37% hydrochloric acid solution was pumped into the micromixer 4 by a pump 6. The methyl glyphosate-containing reaction mixture was fully mixed with the 37% hydrochloric acid solution in the micromixer 4, and then transported to a microchannel reactor 5 for neutralization reaction at 15° C. for 2 min to obtain an acidic reaction mixture. The acidic reaction mixture was directly transported to a microchannel reactor 6 for rapid heating. After being heated to 80° C., the acidic reaction mixture was transported to back pressure valve 2 (7 bar). Pressures of the microchannel reactors 5 and 6 were controlled and adjusted by the back pressure valve 2. The acidic reaction mixture was outputted from the back pressure valve 2 to enter a reaction vessel 1 for desolventization at 90° C. for 15 min to remove solvents, low-boiling by-product methyl chloride to obtain a desolvated product. The desolvated product was sequentially transported to a reaction vessel 2 for hydrolysis reaction at 100° C. for 30 min, and continuously transported to a reaction vessel 3 for complete hydrolysis reaction at 115° C. for 35 min, so as to obtain a hydrolysis product. During the hydrolysis reaction, water in the reaction system was continuously evaporated, the temperature of the reaction mixture was increased to promote the hydrolysis reaction rate. The hydrolysis product in the reaction vessel 3 was directly transported to a continuous crystallizer for cooling crystallization to obtain a crude glyphosate product. The crude glyphosate product was filtered and dried to obtain a glyphosate finished product with a purity of 98%, a total yield of 85% based on glycine. The total reaction time was 69 min.

It should be noted that the embodiments described above are merely to illustrate this application rather than limiting the scope of this application. Therefore, any other changes and modifications made by those skilled in the art without departing from the spirit of the application shall fall within the scope of this application defined by the appended claims.

What is claimed is:

1. A fully-continuous synthesis method of glyphosate using a fully-continuous synthesis system, the fully-continuous synthesis system comprising a first micromixer, a second micromixer, a third micromixer, a fourth micromixer, a first microchannel reactor, a second microchannel reactor, a third microchannel reactor, a fourth microchannel reactor, a fifth microchannel reactor, a sixth microchannel reactor, a dynamic rotary reactor, a buffer tank, a first back pressure valve, a second back pressure valve, a first reaction vessel, a second reaction vessel, a third reaction vessel, and a continuous crystallizer; and the fully-continuous synthesis method comprising:
(1) dissolving paraformaldehyde in a first solvent to obtain a first reactant liquid; dissolving a base in a second solvent to obtain a second reactant liquid; mixing the first reactant liquid with the second reactant liquid in the first micromixer followed by depolymerization in the first microchannel reactor to obtain a depolymerization product; dissolving or dispersing glycine in a third solvent to obtain a third reactant liquid; mixing the third reactant liquid with the depolymerization product in the second micromixer followed by addition reaction in the second microchannel reactor to generate a N, N-dihydroxymethylglycine-containing reaction mixture; transporting the N, N-dihydroxymethylglycine-containing reaction mixture to the buffer tank; and quantitatively outputting, by a plunger pump, the N, N-dihydroxymethylglycine-containing reaction mixture from the buffer tank to the third micromixer;
(2) mixing the N, N-dihydroxymethylglycine-containing reaction mixture with dimethyl phosphite in the third micromixer followed by esterification reaction in the third microchannel reactor and the fourth microchannel reactor to generate a methyl glyphosate-containing reaction mixture, wherein a temperature of the fourth microchannel reactor is higher than that of the third microchannel reactor, and a reaction pressure in the third microchannel reactor and a reaction pressure in the fourth microchannel reactor are adjusted by the first back pressure valve; and
(3) transporting the methyl glyphosate-containing reaction mixture to the fourth micromixer through the first back pressure valve; mixing the methyl glyphosate-containing reaction mixture with an acid in the fourth micromixer followed by neutralization reaction in the fifth microchannel reactor to obtain an acidic reaction mixture; transporting the acidic reaction mixture to the sixth microchannel reactor for heating, wherein a pressure of the fifth microchannel reactor and a pressure of the sixth microchannel reactor are adjusted by the second back pressure valve; transporting the acidic reaction mixture to the first reaction vessel through the second back pressure valve for desolventization to obtain a desolvated product; transporting the desolvated product sequentially to the second reaction vessel and the third reaction vessel to allow complete hydrolysis reaction, so as to obtain a hydrolysis product; transporting the hydrolysis product to the continuous crystallizer for cooling crystallization to obtain a crude glyphosate product; and subjecting the crude glyphosate product to filtration and drying to obtain a glyphosate finished product with a purity greater than 98% and a total yield greater than 85% based on glycine.

2. The fully-continuous synthesis method of claim 1, wherein in step (1), the base is selected from the group consisting of liquid ammonia, triethylamine, trimethylamine, tributylamine, diethylamine, N, N-diisopropylethylamine and sodium methoxide; and
in step (3), the acid is selected from the group consisting of a 10 wt. % aqueous hydrogen chloride solution, a 20 wt. % aqueous hydrogen chloride solution, a 30 wt. % aqueous hydrogen chloride solution, a 37 wt. % aqueous hydrogen chloride solution, a methanolic hydrogen chloride solution, formic acid, acetic acid, a 10 wt. % aqueous phosphoric acid solution, a 20 wt. % aqueous phosphoric acid solution, a 30 wt. % aqueous phosphoric acid solution and a 37 wt. % aqueous phosphoric acid solution.

3. The fully-continuous synthesis method of claim 1, wherein in step (1), the first solvent and the third solvent are each independently selected from the group consisting of pentanol, n-butanol, isobutanol, tert-butanol, n-propanol, isopropanol, ethanol, methanol, ethyl ether, acetone, butanone and methyl isobutyl ketone.

4. The fully-continuous synthesis method of claim 1, wherein the dimethyl phosphite is fed into the third micromixer in a solvent-free manner or in the presence of a fourth solvent;
the acid is fed into the fourth micromixer in a solvent-free manner or in the presence of a fifth solvent; and
the second solvent, the fourth solvent and the fifth solvent are each independently selected from the group consisting of water, pentanol, n-butanol, isobutanol, tert-butanol, n-propanol, isopropanol, ethanol, methanol, acetone and methyl isobutyl ketone.

5. The fully-continuous synthesis method of claim 1, wherein in step (1), a molar ratio of the base to the glycine is 0.6-0.95:1, and a molar ratio of the paraformaldehyde to the glycine is 1.0-3.0:1; and
in step (2), a molar ratio of the dimethyl phosphite to the glycine is 1.0-1.4:1, and a molar ratio of the acid to the glycine is 1.0-10:1.

6. The fully-continuous synthesis method of claim 1, wherein the depolymerization is performed in the first microchannel reactor at 30-60° C. for 1-9 min;
the addition reaction is performed in the second microchannel reactor at 45-80° C. for 6-12 min;
the esterification reaction is performed in the third microchannel reactor at 50-80°° C. for 1-8 min;
the esterification reaction is performed in the fourth microchannel reactor at 60-90°° C. for 5-15 min;
the neutralization reaction is performed in the fifth microchannel reactor at 0-30° C. for 0.5-3 min;
the acidic reaction mixture is heated in the sixth microchannel reactor at 90-190° C., and a residence time of the acidic reaction mixture in the sixth microchannel reactor is 0.5-3 min;
the first reaction vessel is set at 80-150° C., and a residence time of the acidic reaction mixture in the first reaction vessel is 5-40 min;
the hydrolysis reaction is performed in the second reaction vessel at 80-150° C. for 5-40 min;
the hydrolysis reaction is performed in the third reaction vessel at 90-160°° C. for 5-40 min; and
the cooling crystallization is performed in the continuous crystallizer at 0-80° C. for 1-30 min.

7. The fully-continuous synthesis method of claim 1, wherein the first micromixer and the second micromixer are configured to perform dynamic vortex mixing, each having an inlet size of 1.0-50 mm, an outlet size of 1.0-50 mm, a mixing chamber diameter of 5.0-500 mm and a height of 5.0-100 mm;
the third micromixer and the fourth micromixer are each a Z-shaped plate-type micromixer with an inner diameter of 0.5-50 mm and a length of 0.1-100 m; and
each of the first microchannel reactor, the second microchannel reactor, the third microchannel reactor, the fourth microchannel reactor, the fifth microchannel reactor and the sixth microchannel reactor has a plate or tubular microchannel structure with an inner diameter of 1.0-100 mm and a length of 10-10000 m.

8. The fully-continuous synthesis method of claim 1, wherein the dynamic rotary reactor is a horizontal or vertical multi-stage rotary stirring reactor having a heat exchange jacket, a circular interior structure, an inner diameter of 10-500 mm and a length of 0.1-50 m;
the first reaction vessel, the second reaction vessel and the third reaction vessel each have a diameter of 5-1000 mm and an aspect ratio of 5-50:1; and
the continuous crystallizer has an inlet size of 1.0-50 mm, an outlet size of 10-200 mm, an inner diameter of 1.0-50 mm and a length of 1-200 m.

9. The fully-continuous synthesis method of claim 1, wherein a pressure of the first back pressure valve is 1-10 bar, and a pressure of the second back pressure valve is 1-20 bar.

10. The fully-continuous synthesis method of claim 1, wherein the cooling crystallization is performed in the presence of a solvent selected from the group consisting of water, methanol, ethanol, propanol and isopropanol.
